(19) United States
(12) Patent Application Publication
(10) Pub. No.: US 2010/0235625 A1
(43) Pub. Date: Sep. 16, 2010

(54) TECHNIQUES AND ARCHITECTURES FOR PREVENTING SYBIL ATTACKS

(76) Inventor: Ravi Kant Pandey, Lakhimpur(kheri) (IN)

Correspondence Address: SCHWEGMAN, LUNDBERG & WOESSNER/NOVELL, PO BOX 2938, MINNEAPOLIS, MN, 55402, US

(21) Appl. No.: 12/403,684

(22) Filed: Mar. 13, 2009

(51) Int. Cl. H04L 9/32; H04L 9/08

(52) U.S. Cl. 713/156; 713/155; 380/282

(57) ABSTRACT

Techniques and architectures for preventing Sybil attacks are provided. A node authenticates to a local certificate authority associated with a social networking group. The local certificate authority issues an encrypted certificate with a secret to the node. The node then makes a request to participate in another external group via a remote certificate authority. The remote certificate authority verifies the secret and grants permission to the node to participate in the external group. Also, a dynamic architecture permits local nodes in a social networking group self organize with some nodes becoming local certificate authorities and others becoming regular participants.

### BACKGROUND

In an electronic network environment, particularly in social networks, Sybil attacks are commonplace. With a Sybil attack a malicious user creates multiple fake identities and pretends to be multiple distinct nodes in the system. By controlling a large fraction of the nodes in the system, the malicious user is able to “out vote” honest users in collaborating tasks such as Byzantine failure defenses.

A Byzantine failure is an arbitrary fault that occurs during the execution of an algorithm or system and is a fault that is not consistent. Byzantine faults often result in “crashes” or “send” failures. When a Byzantine fault occurs a system may respond in unpredictable manners unless it is specifically designed to handle Byzantine faults.

The industry has sought to address Sybil attacks in one of two manners: via a centralized approach, or via a decentralized approach.

With a centralized approach there is a centralized site that gives certificates to other sites; so, the centralized site becomes a bottleneck in the network (i.e., too much load on the centralized site).

In decentralized approaches no solution exits that completely removes the Sybil attacks. That is, some solutions exist that just mitigate the effect of Sybil attacks (i.e., the number of Sybil attacks can be bounded, and also maximum number of entities within each group).

So, the industry has taken an approach where bottlenecks exists or are tolerated (centralized approach) or in an effort to improve throughput an alternative approach that simply tries to mitigate the effects of Sybil attacks. Neither approach is an optimal one from the point of view of the industry.

Thus, what are needed are improved approaches for preventing Sybil attacks.

### SUMMARY

In various embodiments, techniques and architectures for preventing Sybil attacks are provided. More specifically, and in an embodiment, a method is provided for preventing a Sybil attack. A node is authenticated for the node to participate in an online group. A request is received from the node for a certificate. The request is encrypted with a public key. The certificate is encrypted with a private key to the node and sent to the node. The certificate includes a secret key. The node provides the encrypted certificate to a remote certificate authority when that node desires to make contacts with other online groups and when the remote certificate authority verifies that the encrypted certificate is unaltered, then permission is granted to the node to participate with the other online groups.

### BRIEF DESCRIPTION OF THE DRAWINGS

FIG. 1 is a diagram of a method for preventing Sybil attacks, according to an example embodiment.

FIG. 2 is a diagram of a method for establishing an architecture used in preventing Sybil attacks, according to an example embodiment.

FIG. 3 is a diagram a Sybil attack prevention system, according to an example embodiment.

FIG. 4 is a diagram of a Sybil attack prevention architecture system, according to an example embodiment.

### DETAILED DESCRIPTION

A “resource” includes a user, content, a processing device, a node, a service, an application, a system, a directory, a data store, groups of users, combinations of these things, etc. The term “service” and “application” may be used interchangeably herein and refer to a type of software resource that includes instructions, which when executed by a machine performs operations that change the state of the machine and that may produce output.

The term “principal” is a special type of resource that includes a verifiable identity within an electronic context. Some example principals include a user and automated services that process on machines (processing devices). Principals can also include physical hardware devices such as proxies, clients, servers, peripherals, databases, bridges, routers, hubs, etc. So, the term principal includes a user but is broader than a user.

A “node” is a processing device used by principals. A processing device is enabled with one or more processors, memory, and/or storage. The term “principal” may be used synonymously with “entity.”

Nodes locally assemble in social networking groups. Each social networking group defines a local network having one or more local credential authorities that issue credentials to the nodes and that authenticate the nodes for participating in the social networking group. The local credential authority also cooperates via the certificates issued to the nodes with a remote credential authority. The remote credential authority authenticates the nodes for participation in other social network groups outside the nodes' local network. The mechanisms for achieving this securely in both a distributed and centralized fashion are discussed in greater detail herein and below.

A “credential” is identity information used by a user or principal to authenticate itself within a secure environment. A “secure environment” is a processing environment that is monitored and requires an authenticated identity to access and also incorporates some form of secure communication, such as secure protocols (secure socket layer (SSL), etc.), encryption, etc. The credential can include such things as passwords, biometric information, digital signatures, digital certificates, keys, etc. Thus, a credential includes a password but can also include other types of identity information, such as some of the items listed above.

A “processing environment” refers to one or more physical processing devices organized within a local network. For example, several computers (nodes) connected via a local area network (LAN) may collectively be viewed as a processing environment. The processing environment also refers to software configurations of the physical processing devices, such as but not limited to operating system, file system, directory service, etc. The phrase “processing environment” may be used synonymously herein with the phrase “physical processing environment.

An “identity service” refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity services may authenticate and establish trust with one another, viewing one another as a specific type of resource. In some cases, the identity service may be viewed as a certificate authority herein and below.

According to an embodiment, some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

An identity service may also provide single sign-on services to a resource. That is, a resource may sign-on to an identity service and acquire identities and credentials to access a variety of other services or resources. In some cases, the identity service is modified or enhanced to perform some of the teachings presented herein and below.

Again, it is noted that a resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, credentials, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, given virtual processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

Various embodiments of this invention can be implemented in existing network architectures, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

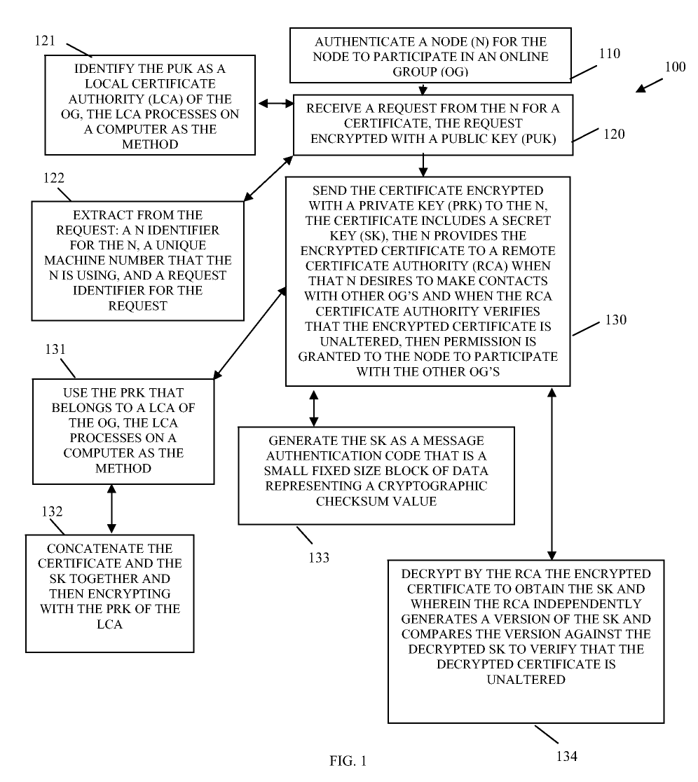

It is within this context, that various embodiments of the invention are now presented with reference to the FIGS. 1-6.

FIG. 1 is a diagram of a method 100 for preventing Sybil attacks, according to an example embodiment. The method 100 (hereinafter “local credential service”) is implemented as instructions in a machine-accessible and computer-readable storage medium. The instructions when executed by a machine (computer, processor, etc.), which is configured to process the local credential service, perform the processing depicted in FIG. 1. The local credential service is also operational over and processes within a local network. The network may be accessible via connections that are wired, wireless, or a combination of wired and wireless.

The local credential service provides distributed credentialing services to nodes of a social networking group. The services provided authenticate to the nodes for participation in the social networking group using a distributed approach and facilitates participation of the nodes in external social network groups via a centralized remote certificate authority. The mechanisms with which this occurs are described in greater detail herein and below.

At 110, the local credential service authenticates a node for that node to participate in an online group, such as an online social networking group. The online social networking group can also be networking groups associated with purchasing such as eBay®, Overstock.com®, etc. In fact, any network based group that requires authentication for an online user can be used or associated with the node. The node itself is being used by a principal or an entity, for purposes of accessing the online group.

In an embodiment, the local credential service can be a modified version of some of the identity services that were discussed and incorporated by reference above. That is, the above-referenced identity services are modified and enhanced to achieve the teachings presented herein.

At 120, the local credential service receives a request from the node that was authenticated for a certificate. The certificate is desired by the node (or the entity or principal associated with the node) for purposes of accessing another external online group outside the local environment of the original online group that the node initially authenticated for access to. The request is encrypted with a public key.

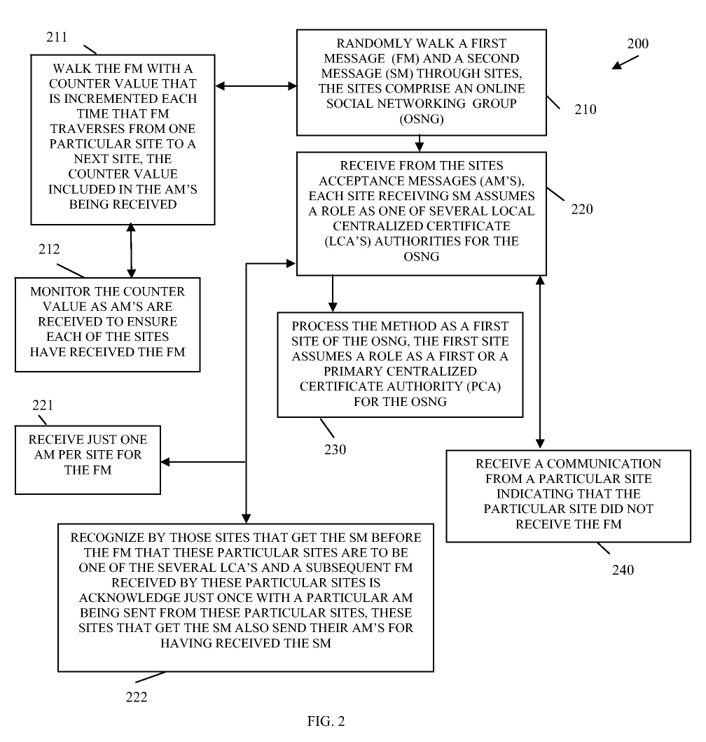

According to an embodiment, at 121, the local credential service identifies the public key as a local certificate authority of the online group. The local credential authority processes on a computer as the method 100 of the FIG. 1. That is the local credential service is the local certificate authority. It is noted that the online group can have more than one local certificate authority or more than one local credential service. This is discussed in greater detail with reference to the method 200 of the FIG. 2, below.

In another case, at 122, the local credential service extracts from the request: a node identifier for the node, a unique machine number that the node is using, and a request identifier. This provides a unique set of information that makes it difficult for an entity to latter launch a Sybil attack within the online group or within other online groups.

At 130, the local credential service sends the certificate encrypted with a private key to the node. The encrypted certificate includes a secret key. Subsequently, the node provides the encrypted certificate to a remote certificate authority (centralized approach to fighting Sybil attacks) when that node desires to make contacts with other online group and when the remote certificate authority verifies that the encrypted certificate is unaltered, then permission is granted to the node to participate with the other online groups.

So, the encrypted certificate includes a secret key that permits the remote certificate authority to verify that the provided encrypted certificate has not be altered or tampered with.

In an embodiment, at 131, the local credential service uses the private key that belongs to a local certificate authority of the online group. Similar to the embodiment at 121, the local certificate authority processes on a computer as the method 100 of the FIG. 1.

Continuing with the embodiment at 131 and at 132, the local credential service concatenates the certificate and the secret key together and then encrypts using the private key of the local certificate authority. So, a private key of the local certificate authority is used to encrypt the certificate that the node uses to authenticate to the remote certificate authority.

According to an embodiment, at 133, the local credential service generates the secret key as a message authentication code that is a small fixed size block of data representing a cryptographic checksum value. This can only be decrypted and discovered by the remote certificate authority.

In another case, at 134, the remote certificate authority decrypts the encrypted certificate to obtain the secret key. The remote certificate authority also independently generates a version of the secret key using a same small fixed size block of data from the certificate and then compares the version that the remote certificate authority produces against the decrypted secret key acquired from the decrypted version of the encrypted certificate. If there is a match then the remote certificate authority knows that the encrypted certificate presented by the node has been unaltered. Thus, the node is granted permission to interact with another online group.

The local credential service provides both a distributed (decentralized) approach to Sybil attacks as well as a centralized approach to the Sybil attacks. This is done via the novel certificate processing achieved via a local certificate authority and a remote certificate authority.

As an example situation or set of circumstances for processing of the local credential service consider the following:

In an initial step, a new node that wants a certificate for use in communicating with other online groups beyond the group that the new node is now communicating with, first uses a decentralized verification process (or any other approach) for getting initial validation.

Next, in a second step and after successful validation, the node sends a request (encrypted with a public key of a certificate authority (CA) (local credential service)) to the CA of a corresponding group which has validated that node in the initial step. The request includes: a Node ID∥unique machine No∥Request id.

For a third step, assuming the node has already been validated in the initial and first step, the CA issues a certificate and sends the certificate concatenated with a message authentication code (MAC), the certificate and the MAC are encrypted with the CA's own private key. The encrypted certificate with the concatenated MAC is sent to the requesting node. The MAC is a secret key that is generated from a small fixed size block of data, known as a cryptographic checksum and is appended to the certificate and then the certificate and the MAC are encrypted with the private key of the CA.

For a fourth step, when a new entity originating from the node wants to make new contacts with other online groups, the new entity follows the processing in the first step.

With the fifth step, the new entity, via the node, sends its encrypted combined certificate and MAC to a Remote CA (RCA) of another online group. The Remote CA upon receipt of the encrypted certificate decrypts as follows:
PU_{CA1}[PR_{CA1}[certificate∥MAC(certificate}]=certificate∥MAC(certificate)

Where PU_{CA1} is the public key of the local CA, PR_{CA1} is the private key that represents what was used to encrypt the certificate and the MAC. This leads to the certificate and the MAC.

In step six, the RCA applies the C(K, certificate) (where C is the checksum algorithm and K is the small fixed block of data acquired from the certificate) using the shared secret key to get the MAC value of the certificate, if this MAC value and attached MAC values are same, this shows no alteration has been done in certificate and proves integrity.

In a seventh state, since the RCA is able to decrypt the certificate with the corresponding local CA's public key it shows authentication of certificate, and also has checked the integrity of the certificate. So, the RCA authenticates the new entity; i.e. gives permission to that new entity so that this new entity can make connection with different nodes of that particular Group (indirect validation).

In an eighth step, any new entity which wants to be connected to the social network, repeats steps 1 to 7.

According to an embodiment, a 32 bit secret key (K) shared among all Centralized Authorities is used; public keys of CA's are known to each node and other CA's.

FIG. 2 is a diagram of a method 200 for establishing an architecture used in preventing Sybil attacks, according to an example embodiment. The method 200 (hereinafter “distributed credentialing establishment service”) is implemented as instructions in a machine-accessible and computer-readable storage medium. The instructions when executed by a machine (computer, processor, etc.), which is configured to process distributed credentialing establishment service, perform the processing depicted in FIG. 2. The distributed credentialing establishment service is also operational over and processes within a social networking group. The network may be accessed via connections that are wired, wireless, or a combination of wired and wireless.

The distributed credentialing establishment service presents distributed mechanism by which local credential services, such as the local credential service discussed above with reference to the method 100 of the FIG. 1, are dynamically established within a local social networking group.

At 210, the distributed credentialing establishment service randomly walks a first message and a second message through sites. The sites comprise an online social networking group. That is, a first message and a second message are sent to sites of a social networking group where when each site receives a message that message is sent on to another member of the online social networking group.

According to an embodiment, at 211, the distributed credentialing establishment service walks the first message with a counter value that is incremented each time the first message traverses from one particular site to a next site. This counter value is included in the acceptance messages (discussed below with reference to the processing at 220).

Continuing with the embodiment at 211 and at 212, the distributed credentialing establishment service monitors the counter value as acceptance messages are received to ensure that each of the sites has received the first message. In other words, the first message fully traverses the sites of the online social networking group.

At 220, the distributed credentialing establishment service receives from the sites acceptance messages. Each site that receives the second message assumes a role as one of several local centralized certificate authorities for the online social networking group. So, multiple local certificate authorities are self-organizing and assuming their role as a local certificate authority to perform the processing that was described above with reference to the method 100 of the FIG. 1.

In an embodiment, at 221, the distributed credentialing establishment service receives just one acceptance message per site for the first message. So, if a site gets a first message more than once, that particular site only sends an acceptance message for the first time that it received the first message.

For another case, at 222, the distributed credentialing establishment service ensures that those sites that get the second message before the first message recognize themselves as one of the several local centralized certificate authorities. Any subsequent first message that is received by a site that first received the second message is acknowledged just once with a particular acceptance message from that site. The sites that get the second message before the first message also send an acknowledgement indicating that they received the second message before the first message. This permits the distributed credentialing establishment service to keep track of the local centralized certificate authorities and permits each of the sites to identify the local centralized certificate authorities.

At 230, the distributed credentialing establishment service processes the method 200 as a first site of the online social networking group. The first site assumes a role as a first or primary centralized certificate authority for the online social networking group.

According to an embodiment, at 240, the distributed credentialing establishment service receives a communication from a particular site indicating that the particular site did not receive the first message. So, the distributed credentialing establishment service ensures that each site gets the first message.

The distributed credentialing establishment service demonstrates how an online social networking group can dynamically self organize into a cluster architecture as those sites that are certificate authorities and as those sites that are not certificate authorities. Each of these certificate authorities behave in the manner discussed above with reference to the method 100 of the FIG. 1.

Consider for further illustration of the distributed credentialing establishment service the following scenario.

In a first step, any one site volunteers to be first a first or primate Centralized Authority (CA or local centralized certificate authority). This is done or determined on the basis of capabilities of the node, the capabilities may be defined in a policy that can be automatically and dynamically evaluated to resolve the capabilities.

In a second step, the site (node) sends random walks of length the first message (W(msg1)) and the second message (2W (msg2)).

In a third step, all the sites that are getting msg1 or msg1 pass them along and send acceptance message (msg3) to the primary CA (established in the first step).

In a fourth step, the sites, who are getting msg2 , think of themselves as CA's (if they haven't already first received msg1) and repeat step 2 to step 4.

In a fifth step, if some site gets more than one of the msg1's, the site sends acceptance to only one CA, which has minimum count value msg1.

For a sixth step, if some site doesn't get any of the msg1's, then that site communicates with a nearby CA.

In an embodiment, all msg1's have count values associated with them and that increase from 1 to w (maximum length for number of links between nodes/sites of any node/site in the group), as msg1 moves from one site to the next site. The CA sends many messages of size w and perhaps 2 w in a random way, so that most nodes do in fact get the messages.

FIG. 3 is a diagram a Sybil attack prevention system 300, according to an example embodiment. The Sybil attack prevention system 300 is implemented as instructions (within a machine-accessible and computer-readable storage medium) that when executed by a machine (processor, etc.) perform, among other things, the processing discussed above with respect to the method 100 of the FIG. 1. Moreover, the Sybil attack prevention system 300 is operational over local and remote network, and the networks are accessible over connections that may be wired, wireless, or a combination of wired and wireless.

The Sybil attack prevention system 300 includes a local credential authority 301 and a remote credential authority 302. Each of these components of the Sybil attack prevention system 300 and their interactions with one another will now be discussed in detail.

The local credential authority 301 is implemented in a computer-readable storage medium and processes on a first processing device of a network. Example processing of the local credential authority 301 was presented above in detail with reference to the method 100 of the FIG. 1.

The local credential authority 301 operates within a local network of nodes that are associated with an online group. The local credential authority 301 authenticates nodes of the local network and provides an encrypted certificate to requesting nodes having a secret key.

When one of the authenticated nodes having the encrypted certificate wants to participate in other online groups, the particular node requests permission from the remote credential authority 302.

According to an embodiment, the requesting nodes make requests for the encrypted certificate and the requests are encrypted with a public key of the local certificate authority 301. the requests include node identifiers for the requesting nodes, unique machine numbers for the machines being used by the requesting nodes, and request identifiers to uniquely identify each of the requests.

In another case, the local certificate authority 301 encrypts the encrypted certificate with a private key of the local credential authority 301.

Continuing with the previous embodiment, the secret is a cryptographic checksum value for a small fixed block of data and is appended to a decrypted version of the certificate before the local credential authority 301 generated the encrypted certificate using the private key.

The remote credential authority 302 is implemented in a computer-readable storage medium and processes on a second processing device of the network. Example processing of the remote credential authority 302 was presented above in detail with reference to the method 100 of the FIG. 1.

The remote credential authority 302 operates external to the local network and assists in managing multiple other online groups over the network and manages the online group.

When one of the authenticated nodes that have the encrypted certificate wants to participate in one of the other online groups that particular node requests permission from the remote certificate authority 302. The remote certificate authority 302 validates the encrypted certificate and the secret to ensure no alteration has taken place. When no alteration has taken place then the particular requesting node is given permission by the remote certificate authority 302 to participate in one of the other online groups.

According to an embodiment, the remote certificate authority 302 decrypts the encrypted certificate using a public key of the local credential authority 301.

Continuing with the previous embodiment, the remote certificate authority 302 independently produces a version of the secret and compares that version against the secret, which was acquired from the decrypted certificate to ensure that there has been no alteration.

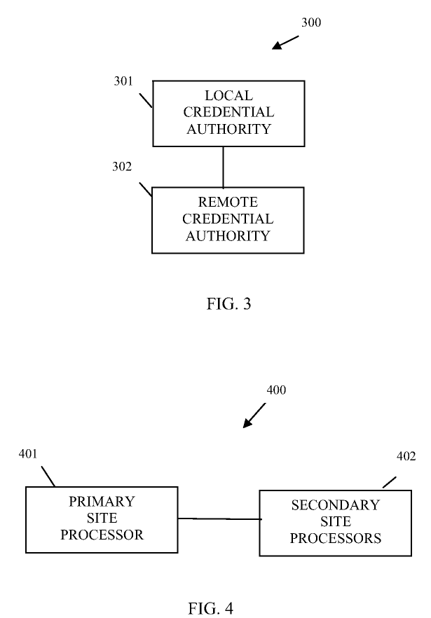

FIG. 4 is a diagram of a Sybil attack prevention architecture system 400, according to an example embodiment. The Sybil attack prevention architecture system 400 is implemented as instructions on or within a machine-accessible and computer-readable storage medium. The instructions when executed by one or more machines (processor, computer, etc.) perform processing depicted with respect to the method 200 of the FIG. 2. The Sybil attack prevention architecture system 400 is also operational over a local social network, the network may be accessed over connections that are wired, wireless, or a combination of wired and wireless.

The Sybil attack prevention architecture system 400 includes a primary site processor 401 and a plurality of second site processors 402. Each of these and their interactions with one another will now be discussed in detail.

The primary site processor 401 processes within a local social networking group. Example aspects of the primary site processor 401 were provided above in detail with reference to the method 200 of the FIG. 2.

The primary site processor 401 volunteers to be a primary local certificate authority for the local social networking group and then walks a first message and a second message randomly through the plurality of secondary site processors 402.

The secondary site processors 402 also process within the local social networking group. Example aspects of the secondary site processors 402 were presented above in detail with reference to the method 200 of the FIG. 2.

When a particular secondary site processor 402 receives the second message before receiving the first message that particular secondary site processor 402 assumes a role of another available local certificate authority for the local social networking group. Also, when a certain secondary site processor 402 receives the first message before receiving the second message that certain secondary site processor 402 assumes an ancillary role within the local social networking group.

Once the primary site processor 401 accounts for each acknowledged first and second message, the local social networking group operates with a plurality of certificate authorities to service the local social networking group.

In an embodiment, each secondary site processor 402 sends just one acknowledgement to the primary site processor 402 upon first receipt of the first message.

Continuing with the previous embodiment, the first message includes a counter value that is incremented each time the first message reaches a new secondary site processor 402. The primary site processor 401 receives the counter value with the acknowledgments to ensure each of the secondary site processors 402 received the first message.

In another case, the particular secondary site processor 402 that receives the second message before the first message also sends an acknowledgement that identifies itself as another certificate authority for the local social networking group.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A computer-implemented method that is adapted to executed by a processor to perform the method, comprising:
authenticating a node for the node to participate in an online group;
receiving a request from the node for a certificate, the request encrypted with a public key; and
sending the certificate encrypted with a private key to the node, the certificate includes a secret key, wherein the node provides the encrypted certificate to a remote certificate authority when that node desires to make contacts with other online groups and when the remote certificate authority verifies that the encrypted certificate is unaltered, then permission is granted to the node to participate with the other online groups.

2. The method of claim 1, wherein receiving further includes identifying the public key as a local certificate authority of the online group, the local certificate authority processes on a computer as the method.

3. The method of claim 1, wherein receiving further includes extracting from the request: a node identifier for the node, a unique machine number that the node is using, and a request identifier for the request.

4. The method of claim 1, wherein sending further includes using the private key that belongs to a local certificate authority of the online group, the local certificate authority processes on a computer as the method.

5. The method of claim 4, wherein sending further includes concatenating the certificate and the secret key together and then encrypting with the private key of the local certificate authority.

6. The method of claim 1, wherein sending further includes generating the secret key as a message authentication code that is a small fixed size block of data representing a cryptographic checksum value.

7. The method of claim 1, wherein sending further includes decrypting by the remote certificate authority the encrypted certificate to obtain the secret key and wherein the remote certificate authority independently generates a version of the secret key and compares the version against the decrypted secret key to verify that the decrypted certificate is unaltered.

8. A computer-implemented method that is adapted to executed by a processor to perform the method, comprising:
randomly walking a first message and a second message through sites, the sites comprise an online social networking group; and
receiving from the sites acceptance messages, wherein each site receiving the second message assumes a role as one of several local centralized certificate authorities for the online social networking group.

9. The method of claim 8 further comprising, processing the method as a first site of the online social networking group, the first site assumes a role as a first or a primary centralized certificate authority for the online social network group.

10. The method of claim 8 further comprising, receiving a communication from a particular site indicating that the particular site did not receive the first message.

11. The method of claim 8, wherein randomly walking further includes walking the first message with a counter value that is incremented each time that first message traverses from one particular site to a next site, the counter value included in the acceptance messages being received.

12. The method of claim 11, wherein receiving further includes monitoring the counter value as acceptance messages are received to ensure each of the sites have received the first message.

13. The method of claim 8, wherein receiving further includes receiving just one acceptance message per site for the first message.

14. The method of claim 8, wherein receiving further includes recognizing by those sites that get the second message before the first message that these particular sites are to be one of the several local centralized certificate authorities and a subsequent first message received by these particular sites is acknowledge just once with a particular acceptance message being sent from these particular sites, these sites that get the second message also send their acceptance messages for having received the second message.

15. A machine-implemented system adapted to be executed on one or more processors, comprising:
a local credential authority implemented in a computer-readable medium and to execute on a first processing device of a network; and
a remote credential authority implemented in a computer-readable storage medium and to execute on a second processing device of the network;
wherein the local credential authority operates within a local network of nodes associated with an online group, and wherein the remote credential authority operates external to the local network and assists in managing multiple other online groups over the network including the online group, the local credential authority authenticates nodes of the local network and provides an encrypted certificate to requesting nodes having a secret key, when one of the authenticated nodes having the encrypted certificate wants to participate in one of the other online groups that particular node requests permission from the remote credential authority and the remote credential authority validates the encrypted certificate and the secret to ensure no alteration has taken place and when no alteration has taken place that particular node is given permission from the remote credential authority to participate with one of the other online groups.

16. The system of claim 15, wherein the requesting nodes make requests for the encrypted certificate and the requests are encrypted with a public key of the local certificate authority and include node identifiers for the requesting nodes, unique machine numbers for the machines being used by the requesting nodes, and request identifiers to uniquely identify each of the requests.

17. The system of claim 15, wherein the local credential authority encrypts the encrypted certificate with a private key of the local credential authority.

18. The system of claim 17, wherein the secret is a cryptographic checksum value for a small fixed block of data and is appended to a decrypted version of the certificate before the local credential authority generated the encrypted certificate using the private key.

19. The system of claim 15, wherein the remote credential authority decrypts the encrypted certificate using a public key of the local credential authority.

20. The system of claim 19, wherein the remote credential authority independently produces a version of the secret and compares that version against the secret acquired from the decrypted certificate to ensure that there has been no alteration.

21. A machine-implemented system adapted to be executed by one or more processors, comprising:
a primary site processor that processes within a local social networking group; and
a plurality of secondary site processors that also processes within the local social networking group;
wherein the primary site processor volunteers to be a primary local certificate authority for the local social networking group and then walks a first message and a second message randomly through the plurality of secondary site processors, when a particular secondary site processor receives the second message before receiving the first message that particular secondary site processor assumes a role of another available local certificate authority for the local social network group, when a certain second site processor receives the first message before receiving the second message that certain second site processor assumes an ancillary role within the local social network group, once the primary site processor accounts for each acknowledged first message and second message, the local social networking group operates with a plurality of certificate authorities to service the local social networking group.

22. The system of claim 21, wherein each secondary site processor sends just one acknowledgement to the primary site processor upon first receipt of the first message.

23. The system of claim 22, wherein the first message includes a counter value that is incremented each time the first message reaches a new secondary site processor and the primary site processor receives the counter value with the acknowledgements to ensure each of the secondary site processors received the first message.

24. The system of claim 21, wherein the particular secondary site processor that receives the second message before the first message also sends an acknowldgement that identifies itself as another certificate authority for the local social networking group.
